(19) United States
(12) Patent Application Publication
(10) Pub. No.: US 2015/0226246 A1
(43) Pub. Date: Aug. 13, 2015

(54) BOLT

(71) Applicant: HALFEN GmbH, Langenfeld (DE)

(72) Inventor: Georg KIRCHNER, Solingen (DE)

(21) Appl. No.: 14/620,994

(22) Filed: Feb. 12, 2015

(30) Foreign Application Priority Data
Feb. 13, 2014 (EP) 14 000 527.3

(51) Int. Cl. F16B 5/02

(52) U.S. Cl. CPC F16B 5/0216

(57) ABSTRACT

A bolt having a head and a shank fixed to the head. The shank having an end side remote from the head. A base face and a relief are formed on the end side of the shank. The relief is molded at least partially in a three-dimensional manner from the base face. The end side is realized in an at least partially colored manner.

### CROSS-REFERENCE TO RELATED APPLICATIONS

The present application claims priority of EP 14 000 527.3, filed Feb. 13, 2014, the priority of this application is hereby claimed and this application is incorporated herein by reference.

### BACKGROUND OF THE INVENTION

The invention relates to a bolt of the generic type having a head and a shank.

It is known to indicate characteristics of the bolt, for example the strength class, the material grade, the bolt type, the manufacturer's mark or the like on the head of a bolt. By way of the characteristics, it is possible to determine whether the bolt meets the specifications of a technical construction from a technical point of view and can thus be built into the construction.

Once the bolt has been built into the construction, the bolt head can frequently no longer be seen. This has the drawback that after the bolt has been built into the construction, it is no longer possible to ascertain whether the mounted bolt meets the specifications of the technical construction from a technical point of view. If bolts which do not meet the specifications of the technical construction are used, the construction can fail.

Subsequent ascertaining of the technical suitability of the bolt mounted in the technical construction is necessary for example when a surveyor is intended to technically check whether the construction meets the building specifications from a technical point of view. However, if the bolt has been built into the technical construction such that the characteristics provided on the head of the built-in bolt are no longer visible, the surveyor can also not ascertain whether the bolt intended for the construction has been mounted. Thus, the surveyor cannot ascertain whether the construction meets the technical specifications.

### SUMMARY OF THE INVENTION

The invention is based on the object of developing a bolt of the generic type such that, after the bolt has been mounted in a technical construction, it is possible to ascertain whether the built-in bolt meets the specifications of the construction from a technical point of view.

According to the invention, the bolt comprises a head and a shank fixed to the head, wherein the shank comprises an end side remote from the head. A base face and a relief are formed on the end side of the shank, wherein the relief is molded at least partially in a three-dimensional manner from the base face. The end side is realized in an at least partially colored manner.

It is possible to draw conclusions relating to the characteristics of the bolt, for example the strength class of the bolt, the material grade of the bolt, the bolt type, the bolt manufacturer or the like, from the relief provided on the end side of the shank and from the partially colored realization of the end side. These conclusions regarding the characteristics of the bolt can be drawn whenever the end side of the shank of the mounted bolt is visible, and thus the relief formed thereon and the colored realization of the end side are visible. The head of the built-in bolt does not have to be visible in this case. Once the end side of the built-in bolt is discernible, a surveyor can use the relief and the colored realization of the end side of the bolt to ascertain at any time whether the bolt meets the technical specifications of the construction from a technical point of view.

According to one configuration of the invention, the relief projects at least partially beyond the base face. Alternatively, the relief is at least partially sunk into the base face. Of course, it is also possible for the relief exclusively to project beyond the base face or to be sunk into the latter. As a result of the relief projecting beyond the base face and/or of the relief being sunk into the base face, the relief has a three-dimensional structure. On account of this three-dimensional structure of the relief, the relief remains durably discernible over long periods of time, in particular even under environmental stresses which can result for example in corrosion and can eliminate a colored marking. In addition, as a result of the three-dimensional structure of the relief, it is harder for third parties to manipulate the relief on the mounted bolt. As a result, it is possible to reliably ensure that the relief, in combination with the colored realization of the end side of the shank of the bolt, reproduces the characteristics of the bolt.

Advantageously, the relief comprises at least one geometrical figure, and the figure preferably has a spacing from the base face. Such a figure can be for example a triangle, a square, a rectangle, a polygon, a circle, or the like. Expediently, each figure is assigned at least one characteristic in combination with the colored realization of the end side, and in particular a geometrical figure stands for a property of the bolt. For example, a circle can symbolize the material used for the bolt, for example steel, a rectangle can symbolize for example the strength class, or the like. By way of the geometrical figure formed in the relief and by way of the colored configuration of the end side, a surveyor can ascertain which technical characteristics the bolt has. The surveyor can deduce therefrom whether the built-in bolt meets the specifications of the construction from a technical point of view.

Advantageously, the geometrical figure is a rectangle, wherein one side of the rectangle is open in the middle. In this way, the relief indicates that the bolt is intended for an anchoring rail or Halfen rail. Advantageously, the greatest spacing of the figure from the base face is at least 1 mm and at most 4 mm, in particular at least 2 mm and at most 3 mm. In this way, the relief and in particular the figure reproduced in the relief on the end side of the shank of the bolt are easily discernible. Also, in this way, the bolt can be manufactured in a technically simple manner.

The relief can comprise at least one three-dimensionally formed, geometrical body. Such a body is for example a cuboid, a cube, a pyramid, a prism or the like.

The relief expediently comprises a three-dimensionally formed letter. For example, the letter can be an “H”. Expediently, the relief comprises at least one punctuation mark, in particular a dash, a period, a comma, a semicolon, a colon or the like. Advantageously, the relief comprises at least one three-dimensionally formed number. As a result, characters are reproduced in the relief, said characters providing information about the technical properties of the bolt. By way of the combination of letters, numbers and punctuation marks, the technical information about the technical properties of the bolt can be applied to the bolt in an easy manner.

Advantageously, only the end side of the bolt is colored. Particularly advantageously, only the relief on the bolt is colored. As a result, the contrast between the colored and uncolored region of the bolt is great. In addition, as a result of the only local coloring of the bolt on the end side or in particular only on the relief, only a little color is applied, since the color is applied only to the subsequently visible point on the bolt, specifically to the end side of the shank.

In one embodiment the head of the bolt is in the form of a hammer head. Expediently, the head of the bolt can be in the form of a hook head. In particular, bolts having a hammer head or having a hook head are suitable, on account of the rectangular head geometry, for insertion into a narrow bore in a fastening carrier. Once the bolt has been inserted into the fastening carrier, the head of the bolt is largely enclosed by the fastening carrier and the head is no longer visible. However, the end side of the shank of the bolt is visible. Via the relief formed on the end side and on account of the colored realization of the end side, the characteristics of the bolt can be ascertained even after the bolt has been mounted in a fastening carrier.

The various features of novelty which characterize the invention are pointed out with particularity in the claims annexed to and forming a part of the disclosure. For a better understanding of the invention, its operating advantages, specific objects attained by its use, reference should be had to the drawings and descriptive matter in which there are illustrated and described preferred embodiments of the invention.

### BRIEF DESCRIPTION OF THE DRAWING

In the drawing:

FIGS. 1 and 2 show perspective views of the bolt with a shank in the non-built-in and mounted state in a technical construction,

FIGS. 3 to 7 show plan views of the end side of the shank of the bolt with different variant embodiments of a relief,

FIGS. 8 to 10 show schematic sectional illustrations of the bolt with the relief on the end side of the shank of the bolt in different variant embodiments,

FIGS. 11 and 12 show side views of the bolt with a hammer head and a hook head, and a respectively associated fastening carrier,

FIG. 13 shows a schematic plan view of the end side and the head of the bolt, and

FIGS. 14 and 15 show perspective views of the bolt in the non-built-in and in the mounted state in a further embodiment.

### DETAILED DESCRIPTION OF THE INVENTION

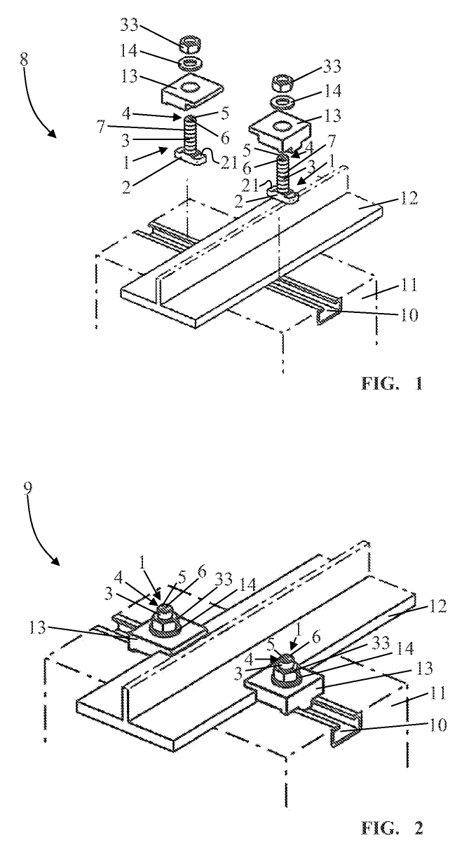

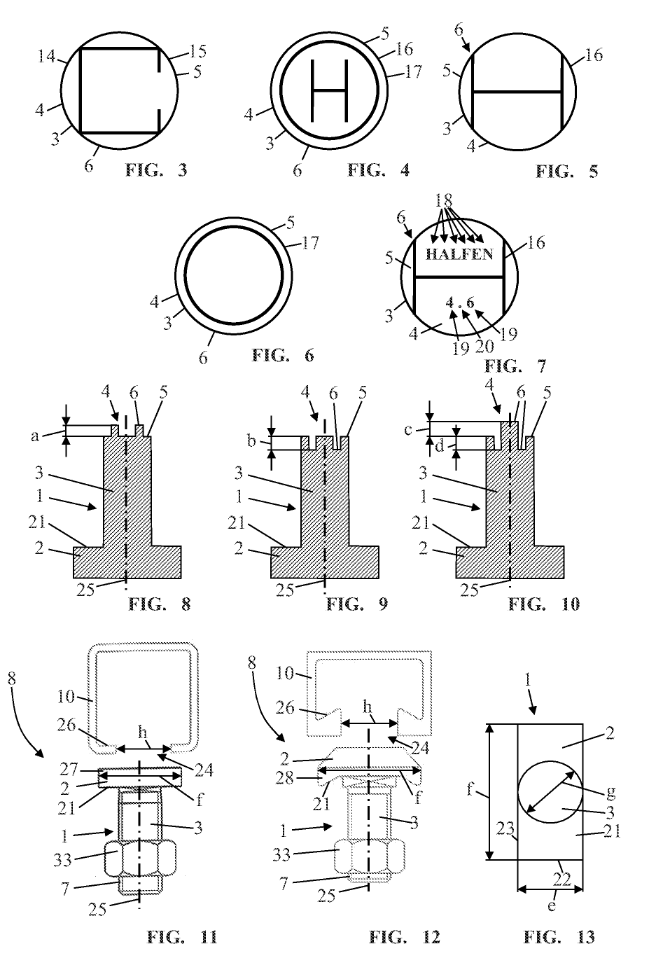

FIG. 1 shows, as exemplary embodiment, a bolt 1 in the non-built-in state 8 and a fastening carrier 10 fixed to a structural element 11. The bolt 1 comprises a head 2. Arranged on the head 2 is a shank 3. The shank 3 comprises an end side 4 remote from the head 2. Formed on the end side 4 are, as shown in FIGS. 8 to 10, a base face 5 and a relief 6. The relief 6 is molded at least partially in a three-dimensional manner from the base face 5. The end side 4 is realized in an at least partially colored manner.

FIG. 1 shows an exemplary embodiment of a technical construction in which the bolt 1 is built in. The technical construction comprises the fastening carrier 10. The fastening carrier 10 is fixed to the structural element 11. The fastening carrier 10 is formed such that the head 2 of the bolt 1 can be supported in the fastening carrier 10. In this case, the head 2 of the bolt 1 in the mounted state 9 is located mostly within the fastening carrier 10 (FIG. 2). As a result of the head 2 of the bolt 1 being supported in the fastening carrier 10, forces can be transmitted between the bolt 1 and the fastening carrier 10. In the exemplary embodiment, the fastening carrier 10 is in the form of a rail, specifically as an anchoring rail or Halfen rail. The fastening carrier 10 can also be realized as a mounting plate.

The technical construction comprises a steel beam 12. In the exemplary embodiment, the steel beam 12 rests on the structural element 11 transversely to the fastening carrier 10. In the exemplary embodiment, according to FIGS. 1 and 2, in order to fasten the steel beam 12 to the fastening carrier 10 and the structural element 11, two bolted connections of identical design are used. With the aid of the bolted connections, the steel beam 12 is connected firmly to the structural element 11. Each bolted connection comprises, in addition to the bolt 1, a rail clip 13. In the mounted state 9, the rail clip 13 rests both on the steel beam 12 and on the fastening carrier 10. The rail clip 13 is firmly bolted to the fastening carrier 10 via the bolt 1, via a washer 14 and via a nut 33 screwed onto the thread 7 of the bolt 1. In the mounted state 9, the rail clip 13 firmly clamps the steel beam 12 to the fastening carrier 10.

The structural element 11 can comprise a part of a building, for example a wall, a ceiling, a floor, a foundation or the like. The fastening carrier 10 is sunk into the part of the building. The fastening carrier 10 and the part of the building are connected firmly together. By way of the bolted connection having the bolt 1 and rail clip 13, the steel beam 12 is thus firmly connected to the part of the building, and forces can be transmitted between the steel beam 12 and the part of the building. In order to be able to transmit forces between the steel beam 12 and the structural element 11 and the fastening carrier 10 via the bolted connection, the bolted connection has to comply with specifications of the technical construction from a technical point of view. An essential component of the bolted connection and thus an essential component for meeting the technical specifications of the bolted connection is in this case the bolt 1.

The bolt 1 has to meet the specifications of the technical construction from a technical point of view. Characteristics—not illustrated in the figures—are impressed on the head 2 of the bolt 1. The characteristics applied to the head 2 indicate for example the manufacturer, the strength class or material grade, the bolt type, and the like. While the head 2 of the bolt 1 is visible in the non-built-in state 8 according to FIG. 1, in the mounted state 9 according to FIG. 2, the head 2 of the bolt 1 is not visible. Thus, in the mounted state 9, the characteristics applied to the head 2 cannot be seen. However, it is precisely in the mounted state 9 that it has to be ascertainable whether the bolt 1 meets the specifications of the technical construction from a technical point of view. For example, a surveyor has to be able to technically assess, check and approve the construction in the mounted state 9. To this end, the surveyor has to be capable of ascertaining at any time whether the bolt meets the specifications of the construction from a technical point of view.

In the mounted state 9, according to the exemplary embodiment according to FIG. 2, the end side 4 of the shank 3 of the bolt is visible. Thus, the relief 6 formed on the end side 4 and the colored realization of the end side 4 are also visible. The relief 6 and the colored realization of the end side 4 indicate technical characteristics of the bolt. Thus, the surveyor can use the relief 6 and the colored configuration of the end side 4 even in the mounted state 9 to ascertain whether the bolt meets the specifications of the construction from a technical point of view.

Different exemplary embodiments of reliefs 6 are shown in FIGS. 3 to 7. Different reliefs 6 reflect different characteristics of the bolt 1. A relief 6 can in this case comprise a geometrical figure, for example. The geometrical figure in turn allows conclusions to be drawn as to the manufacturer, the material grade, the strength class, the bolt type and the like.

In the exemplary embodiment according to FIG. 3, a rectangle 14 is formed as the geometrical figure, wherein the right-hand side 15 of the rectangle 14 is open in the middle. The geometrical figure indicates for example the manufacturer. Furthermore, the geometrical figure indicates the use purpose of the bolt 1, specifically that the bolt 1 can be built into an anchoring rail or Halfen rail.

In the exemplary embodiment according to FIG. 4, a three-dimensionally formed “H” 16 is comprised in the relief 6. The “H” 16 indicates for example the manufacturer or the use purpose of the bolt 1. Furthermore, in the exemplary embodiment according to FIG. 5, the relief 6 comprises a circle 17. The center of the circle 17 is arranged at the same location as the center of the end side 4, which is circular in plan view. The circle 17 indicates for example the strength class of the bolt 1. In the exemplary embodiment according to FIG. 5, the relief 6 comprises the “H” 16. In the exemplary embodiment according to FIG. 6, the relief 6 comprises the circle 17.

In the exemplary embodiment according to FIG. 7, the relief 6 has a number of letters 18. The letters 18 produce the lettering “HALFEN”. The letter combination “HALFEN” provides an indication of the manufacturer. Furthermore, the relief 6 has numbers 19 and punctuation marks 20. In the exemplary embodiment, the number combination “4.6” is indicated in the relief 6. The number combination “4.6” provides an indication of the strength class of the bolt 1. In addition, the relief 6 has the “H” 16 in the exemplary embodiment according to FIG. 7.

In further variant embodiments, the relief 6 can comprise at least one three-dimensionally formed, geometrical body. Examples of such a three-dimensionally formed geometrical body are a cuboid, a cube, a pyramid, a prism or the like.

In all the variant embodiments, the end side 4 of the bolt 1 is colored. It is advantageous to color only the end side 4 of the bolt 1, since the end side 4 is visible in the mounted state 9. Coloring all of the bolt 1 is not necessary, and in particular parts of the bolt 1 that are not visible, for example the head 2, are not colored in the exemplary embodiment. In further variant embodiments, it is also possible for only the relief 6 to be colored. It is also possible for the relief 6 and the base face 5 to be colored, wherein the relief 6 bears a different color than the color of the base face 5. The use of only one color, of a plurality of colors, of color combinations or the like provides characteristics of the bolt 1. A surveyor can read therefrom which bolt 1 it is and whether the bolt 1 meets the specifications of the construction from a technical point of view.

By way of the configuration of the relief 6 on the end side 4 of the bolt 1 with geometrical figures, geometrical bodies, letters 18, numbers 19, punctuation marks 20, and with a colored configuration of the end side 4, a number of characteristics of the bolt 1 are reproduced in the relief 6. In spite of the limited size of the end side 4 of the bolt 1, a number of characteristics can be applied to the end side 4 of the bolt 1 with the aid of the relief 6.

As shown in FIGS. 8 to 10, the relief 6 is molded at least partially in a three-dimensional manner from the base face 5. In this way, the relief 6 is provided with a three-dimensional structure. The three-dimensional structure of the relief 6 remains durably readily visible even under environmental influences such as weathering or the like. In the exemplary embodiment according to FIG. 8, the relief 6 projects only beyond the base face 5. The relief 6 thus has a spacing from the base face 5 in locations, specifically an elevation of height a.

In the exemplary embodiment according to FIG. 9, the relief 6 is only sunk into the base face 5. The relief 6 thus has a spacing from the base face 5 in locations, specifically a depression of depth b.

In the exemplary embodiment according to FIG. 10, the relief 6 projects beyond the base face 5 in locations with a spacing, specifically an elevation of height c, and the relief 6 is sunk into the base face 5 in locations with a spacing, specifically a depression of depth d.

In all the exemplary embodiments according to FIGS. 8 to 10, the greatest spacing (a, b, c, d) of the relief 6 from the base face 5 is about 3 mm. It may be advantageous for the greatest spacing (a, b, c, d) of the relief 6 from the base face 5 to be at least 1 mm and at most 4 mm, in particular at least 2 mm and at most 3 mm.

FIGS. 11 and 12 show two possible variant embodiments of the head shape of the head 2 of the bolt 1 and the associated fastening carriers 10. The head 2 has an underside 21 in both variant embodiments. The shank 3 is integrally formed on the underside 21. As is discernible in FIGS. 1 and 13, the underside 21 is approximately rectangular in plan view. The rectangular underside 21 has a first side 22 and a second side 23 positioned orthogonally thereto. The first side 22 has the side length e and the second side 23 has the side length f. The side length e of the first side 22 is shorter than the side length f of the second side 23. In the exemplary embodiment, the side length e of the first side 22 is approximately as great as the outside diameter g of the shank 3.

The fastening carrier 10 has an opening 24 with a width h. The width h is greater than the side length e of the first side 22 and shorter than the side length f of the second side 23. As a result of the shorter side length e of the first side 22 compared with the longer side length f of the second side 23, the bolt 1 can be rotated such that the bolt 1 can be introduced into the opening 24, shown in FIGS. 11 and 12, in the fastening carrier 10. Once the bolt 1 has been introduced into the fastening carrier 10, the bolt 1 is rotated through about 90° about the axis of symmetry 25, shown in FIGS. 11 and 12, of the bolt 1. Since the second side length 11 of the underside 21 of the head 2 is greater than the width h of the opening 24, the bolt 1 is arranged in this position within the fastening carrier 10. The bolt 1 can no longer be removed from the opening 24 in the fastening carrier 10 without the bolt 1 being rotated. In the mounted state 9 according to FIG. 2, the underside 21 rests on the inner side 26 of the fastening carrier 10. In this way, forces can be transmitted between the fastening carrier 10 and the bolt 1. The head 2 of the bolt 1 is not visible in the mounted state 9.

The head 2 of the bolt 1 is in the form of a hammer head 27 in the exemplary embodiment according to FIGS. 1, 11 and 14. The hammer head 27 has a rectangular shape both in plan view according to FIG. 13 and in side view according to FIG. 11. The fastening carrier 10, specifically the anchoring rail or Halfen rail, is shaped in a manner corresponding to the hammer head 27 such that the underside 21 of the head 2 rests flat against the inner side 26 of the fastening carrier 10 in locations in the mounted state 9.

In a further exemplary embodiment according to FIG. 12, the head 2 of the bolt 1 is in the form of a hook head 28. The hook head 28 corresponds to the hammer head 27 in plan view according to FIG. 13. The hook head 28 has a rectangular shape in plan view according to FIG. 13. In side view according to FIG. 12, the underside 21 of the hook head 28 extends at an angle α from the shank 3. The angle α is measured between the shank 3 and underside 21 in side view according to FIG. 12. The angle α is less than 90°. The fastening carrier 10 according to FIG. 12 is shaped in a manner corresponding to the hook head 28 such that the underside 21 of the hook head 28 rests flat against the inner side 26 of the fastening carrier 10 in locations in the mounted state 9. The hook shape 28 prevents the bolt 1 from slipping in the mounted state 9 and thus additionally supports the construction.

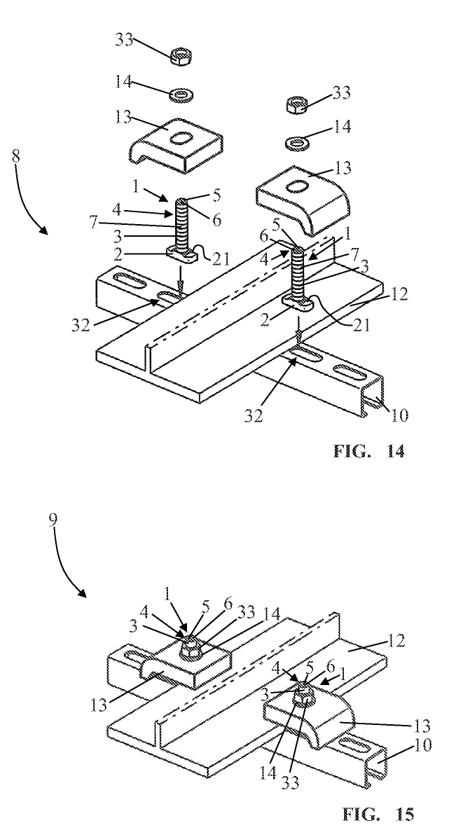

FIGS. 14 and 15 show a further exemplary embodiment of a technical construction in which the bolt 1 is built in. Identical reference signs in all of FIGS. 1 to 15 designate identical components. The fastening carrier 10 is in the form of a rail, specifically of an anchoring rail or Halfen rail, in this exemplary embodiment according to FIGS. 14 and 15, too. Slots 32 having two opposite narrow sides and two opposite long sides are formed on the rail bottom 31. The length of the narrow side of the slot 32 is longer than the side length e, shown in FIG. 13, of the first side 22 of the head 2 of the bolt 1 and shorter than the side length f of the second side 23 of the head 2 of the bolt 1. The long side of the slot is longer than the side length f of the second side 23 of the head 2 of the bolt 1. In this way, the head 2 of the bolt 1 can be introduced into the slot 32. Once the head 2 of the bolt 1 has been introduced into the slot 32, the head 2 of the bolt 1 disappears in the fastening carrier 10 in the mounted state 9 such that the head 2 is not visible in the mounted state 9. Nevertheless, the end side 4 having the relief 6 and the colored configuration of the end side 4 is visible (FIG. 15). In this way, in this exemplary embodiment of the construction, too, in the mounted state 9 of the bolt 1, the relief 6 and the colored configuration of the end side 4 of the shank 3 of the bolt 1 can be used to ascertain whether the bolt 1 meets the specifications of the technical construction from a technical point of view.

While specific embodiments of the invention have been shown and described in detail to illustrate the inventive principles, it will be understood that the invention may be embodied otherwise without departing from such principles.

We claim:

1. A bolt, comprising: a head; and a shank fixed to the head, wherein the shank has an end side remote from the head, and a base face is formed on the end side of the shank, wherein a relief is formed on the end side of the shank, the relief being molded at least partially in a three-dimensional manner from the base face, and the end side being at least partially colored.

2. The bolt according to claim 1, wherein the relief projects at least partially beyond the base face.

3. The bolt according to claim 1, wherein the relief is at least partially sunk into the base face.

4. The bolt according to claim 1, wherein the relief comprises at least one geometrical figure that has a spacing from the base face.

5. The bolt according to claim 4, wherein the geometrical figure is a rectangle, wherein the rectangle has one side with a central opening.

6. The bolt according to claim 4, wherein the spacing of the figure from the base face has a greatest extent of between at least 1 mm and at most 4 mm.

7. The bolt according to claim 4, wherein the geometrical figure is a polygon.

8. The bolt according to claim 1, wherein the relief comprises at least one three-dimensionally formed, geometrical body.

9. The bolt according to claim 8, wherein the geometrical body is a cuboid.

10. The bolt according to claim 8, wherein the geometrical body is a cube.

11. The bolt according to claim 8, wherein the geometrical body is a pyramid.

12. The bolt according to claim 8, wherein the geometrical body is a prism.

13. The bolt according to claim 1, wherein the relief comprises at least one three-dimensionally formed letter.

14. The bolt according to claim 13, wherein the letter is H.

15. The bolt according to claim 1, wherein the relief comprises at least one three-dimensionally formed number.

16. The bolt according to claim 1, wherein the head is a hammer head.
